(19) United States
(12) Patent Application Publication
(10) Pub. No.: US 2025/0296512 A1
(43) Pub. Date: Sep. 25, 2025

(54) CENTER CONSOLE SYSTEM FOR USE IN A VEHICLE INTERIOR, AND VEHICLE COMPRISING AT LEAST ONE SUCH SYSTEM

(71) Applicant: Faurecia Innenraum Systeme GmbH, Hagenbach (DE)

(72) Inventor: Volker Doll, Ranschbach (DE)

(21) Appl. No.: 19/084,152

(22) Filed: Mar. 19, 2025

(30) Foreign Application Priority Data
Mar. 25, 2024 (DE) 10 2024 202 803.7

(51) Int. Cl. B60R 7/04; B60N 2/02; B60N 2/90; B60N 3/10; B60R 16/03

(52) U.S. Cl. CPC B60R 7/04; B60N 2/02246; B60N 2/90; B60N 3/10; B60R 16/03

(57) ABSTRACT

A center console system for use in a vehicle interior can comprise a support structure, a center console, and a vehicle seat movable relative to the support structure along a first direction and a second direction. The center console can be arranged next to the vehicle seat and can be connected to the vehicle seat via a first hinge such that a movement of the vehicle seat is transmitted to the center console. The center console can be connected to the support structure via a second hinge in a rotating manner.

### CLAIM FOR PRIORITY

This application claims the benefit of priority to German Application No. 10 2024 202 803.7, filed Mar. 25, 2024, which is hereby incorporated by reference in its entirety.

### TECHNICAL FIELD

The application relates to a center console system for use in a vehicle interior according to the preamble of claim 1. Furthermore, the application relates to a vehicle comprising at least one such center console system.

### BACKGROUND

Vehicles may include center consoles with an armrest. For example, such a center console is described in DE 10 2007 033 532 A1. To ensure that the armrest is suitable for supporting an arm of both a large and a small person, the position of the armrest can be designed to be movable. Although this center console in DE 10 2007 033 532 A1 is suitable for adjusting the support position of the armrest, the design described is relatively complex and not ergonomically advantageous for people of all sizes. In addition, a vehicle seat can be adjustable relative to the cockpit so that it can be ergonomically adjustable for both small and large people. When there is a change of passenger, many settings must be readjusted to produce ergonomic conditions. In addition, many drive components are necessary to adjust the vehicle seat and center console, each via an electric motor.

### SUMMARY

The purpose of the application is therefore to propose a center console system which overcomes one or more of the disadvantages mentioned above. It is a particular object of the present disclosure to propose a center console system which ensures easy handling with a relatively simple and inexpensive construction.

The proposed center console system for use in a vehicle interior can comprises a support structure, a center console, and a vehicle seat movable relative to the support structure and along a first direction and along a second direction.

The center console can be arranged next to the vehicle seat and can be connected to it via a first hinge such that a movement of the vehicle seat is transmitted to the center console.

The center console can be connected to the support structure via a second hinge in a rotating manner.

The first direction can run orthogonally to the second direction. The first hinge can be designed such that the center console is rotatable about a first axis running along a third direction. Additionally or alternatively, the hinge can be designed such that the center console can be rotated about an axis running along or parallel to the third direction. In particular, the third direction can be orthogonal to the first direction and to the second direction. In a right-handed Cartesian coordinate system, the first direction can run along the x-axis, the second direction along the z-axis, and the third direction along the y-axis.

When using the center console system in the interior of a vehicle, the first direction can correspond to the direction of travel of the vehicle. A movement of the vehicle seat along this axis can reduce or increase a distance of the vehicle seat with respect to the support structure—for example, in the form of a cockpit or an instrument panel. The second direction can run along a vertical and in particular correspond to a height adjustment of the vehicle seat. The third direction can run along a horizontal. The vehicle seat can in particular be designed to be arranged rigidly relative to the support structure along the third direction—in particular, to not be displaceable in this third direction.

The center console or at least a part of the center console is in particular firmly connected to the vehicle seat in such a way that a movement of the vehicle seat in the first and second directions is transmitted to the center console. This can be advantageous because a passenger sitting on the seat need only adjust the seat to his or her size, while the center console is also moved into the appropriate position. Storage compartments, cup holders, and/or armrests located in the center console can thus be reached ergonomically. No additional adjustment of the center console is necessary.

The center console and/or the support structure can be designed such that a distance between the first and the second hinges is adjustable.

In one embodiment, at least a part of the center console can be mounted on or in the support structure so that the part can be moved in a translational manner. The entire center console or at least part of the center console can be mounted on the support structure so as to be movable. The movement along the first direction and/or along the second direction can be guided via a linear guide element. For example, the center console can have a pin or a rib, which is mounted in an oblong slot, arranged parallel to the first direction, of the support structure, and is displaceable in this slot.

For example, if the vehicle seat is moved forwards, the entire center console or at least a part of the center console also moves forwards. The first hinge can be moved towards the second hinge. To compensate for this, a cavity can be formed in the support structure into which a front part of the center console can be pushed. Additionally or alternatively, the center console can have a telescopic mechanism or a folding mechanism by means of which a length of the center console and/or a distance between the first and second hinges can be varied.

In one embodiment, the first hinge can connect the center console to the vehicle seat in a rotatable manner, in particular via a connecting rod. A movement of the vehicle seat along the first and/or second direction can, in addition to the corresponding movement of the center console along this or these direction(s), lead to a rotation of the center console relative to the vehicle seat. This can result in an adjustment of the distance between the first and second hinges. Furthermore, an inclination of an armrest arranged on the center console can be adjustable in this way.

The support structure can be part of a cockpit of a vehicle, in particular comprising an instrument panel. For example, the instrument panel can include buttons and controllers for adjusting vehicle functions.

A storage compartment can be formed on the top side of the center console. The center console can have at least one storage compartment and/or a cup holder and/or electrical connections. Furthermore, the center console can be a continuation of the vehicle's instrument panel. In addition, the center console can have walls that at least partially delimit a cavity in the center console. In this cavity, for example, an air duct for connection to at least one vent, an air conditioning unit, a control device for controlling electrical devices, a storage compartment, an ashtray, an infotainment system, a screen, and/or a cup holder can be arranged.

The center console system can have a drive (e.g., a drive member or an actuation member), such as an electric motor. The drive can be arranged and designed to move the vehicle seat together with the center console, relative to the support structure, along the first and/or second direction. The advantage of this design compared to individually adjustable center consoles is that only one drive is required for the seat and center console adjustment. Therefore, the one drive can comprise one motor for movement along the first direction and another motor for movement along the second direction. However, no additional drive is necessary for adjusting the center console. Rather, the drive can be used to adjust the vehicle seat position relative to the first support structure in order to also adjust the center console accordingly. This can lead to savings in cost and weight, since connecting elements for coupling the center console to the vehicle seat are cheaper and lighter than additional drive elements, in particular one or more additional electric motors.

The application further relates to a vehicle comprising at least one center console system according to the above description. The vehicle seat can, for example, be a driver's seat or a passenger seat.

For example, a vehicle can include two center console systems, such that a first center console is coupled to the driver's seat, and a second center console is coupled to the passenger seat. The first and second center consoles can have a common second hinge or separate second hinges.

In one embodiment, only a single center console may be provided, wherein the center console has a first part coupled to the driver's seat and a second part coupled to the passenger seat. The coupling corresponds to the first hinge described above. The first part and the second part of the center console can be moved relative to each other, so that, when the driver's seat is moved, the first part of the center console is moved along with it and is thus adjusted, while, when the passenger seat is moved, the second part of the center console is also moved along with it and is thus adjusted. The first and second parts can move independently of each other. This allows an ergonomic position to be set for both the passenger and the driver at the same time. The first and second parts of the center console can have a common second hinge.

The features and combinations of features mentioned above in the description, as well as the features and combinations of features mentioned below in the description of the figures and/or shown alone in the figures, can be used not only in the combination specified in each case, but also in other combinations or on their own, without departing from the scope of the present disclosure.

### BRIEF DESCRIPTION OF THE DRAWINGS

Exemplary embodiments of the present disclosure are described below with reference to the accompanying drawings. In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is an example of a schematic side view of a center console system.

FIG. 2 is an example of a schematic view of a center console system according to FIG. 1, wherein a cutout (a) shows a perspectival view and a cutout (b) shows a rear view.

FIG. 3 is an example of a schematic view of two center console systems according to FIG. 1 in a vehicle.

### DETAILED DESCRIPTION

In the following, similar elements are marked with similar or identical reference signs.

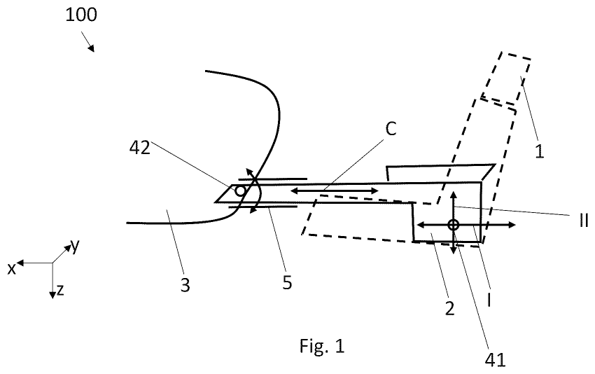

FIG. 1 shows a center console system 100 for use in a vehicle interior, comprising a vehicle seat 1, a center console 2, and a support structure 3. The vehicle seat is movable relative to the support structure 3 along a first direction I and along a second direction II.

In the Cartesian coordinate system shown, the vehicle seat 1 can be moved back and forth along the x-axis. In addition, the vehicle seat 1 can be moved up and down along the z-axis. The center console 2 is arranged next to the vehicle seat 1 and is connected to it via a first hinge 41 such that a movement of the vehicle seat 1 is transmitted to the center console 2. Via a second hinge 42, the center console 2 is connected to the support structure 3 in a rotating manner. The support structure 3 is part of a cockpit of a motor vehicle.

The first hinge 41 is designed such that the center console 2 can be rotated relative to the vehicle seat 1 about an axis parallel to the y-axis. The second hinge 42 is designed such that the center console 2 can be rotated relative to the support structure 3 about a second axis running parallel to the y-axis.

A linear guide element 5 guides a movement of the center console 2. The guide element 5 can also be rotatable relative to the support structure 3. The center console 2 can have a variable length. For example, a telescopic mechanism can be provided by means of which a distance between the first hinge 41 and the second hinge 42 can be changed; in particular, a length of the center console can be adjusted. A length adjustment of the center console 2 is depicted, for example, via a double arrow C.

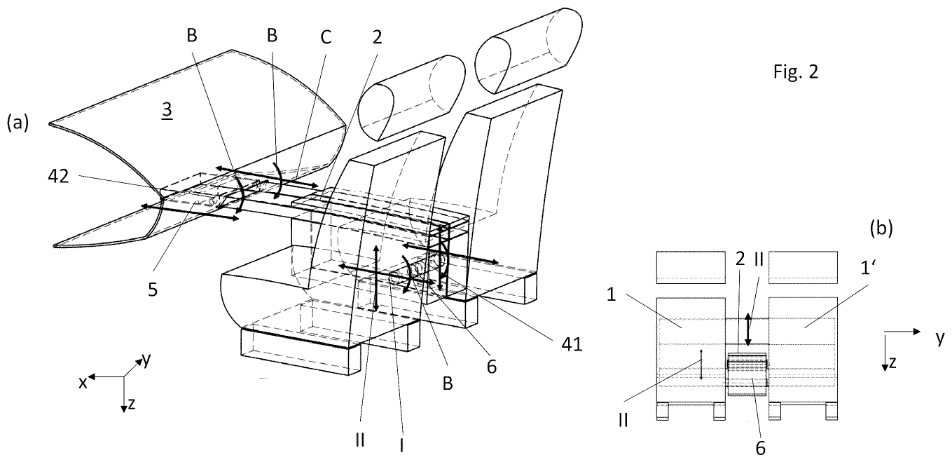

FIG. 2 shows the center console system 100 of FIG. 1, also schematically, but in perspectival view (compare cutout (a)) and in rear view (compare cutout (b)). The center console 2 can be rotatably coupled to the vehicle seat 1 via a connecting rod 6. The rotational mobility is depicted, for example, by the double arrow A. The connecting rod 6 is therefore part of the first hinge 41. Through the hinge 41, a movement of the vehicle seat 1 in direction I and in direction II is transmitted to the center console. If the vehicle seat 1 is moved upwards in the minus z-direction, for example, the center console 2 also moves upwards via the coupling with the connecting rod 6. The vehicle seat 1 here is, for example, a driver's seat. In the example shown, the front passenger seat 1′ is not coupled to the center console 2. The passenger seat is also height-adjustable, i.e., movable along the z-axis. In this case, a movement of the front passenger seat 1′ does not lead to a movement of the center console 2. In another exemplary embodiment, however, the center console 2 can alternatively be coupled to the passenger seat 1′.

The center console 2 is rotatably coupled to the support structure 3 via the second hinge 42. The rotational mobility is depicted, for example, by the double arrows B.

The center console system 100 can include a drive for adjusting the vehicle seat along direction I and/or 2. Such a drive is not shown. In particular, no additional drive is required to adjust the center console 2, since an adjustment of the driver's seat 1 leads to an adjustment of the center console 2.

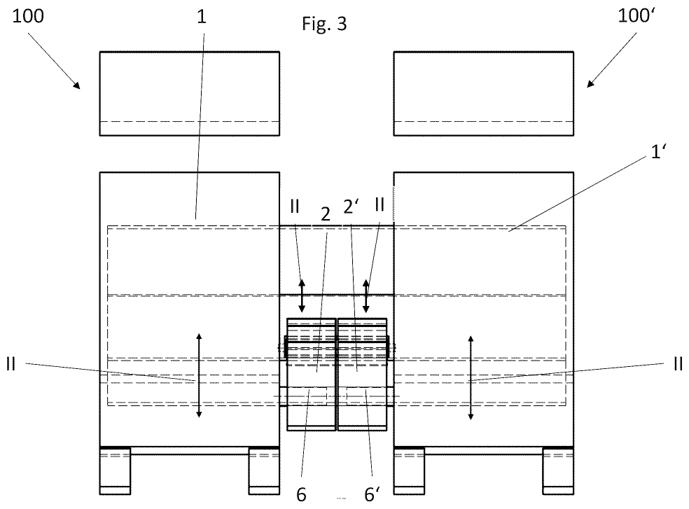

FIG. 3 shows a rear view of an exemplary vehicle interior in which two center console systems 100 and 100′ are each arranged in the manner of the system in FIG. 1. A first center console 2 is coupled to the driver's seat 1 via a first connecting rod 6, and a second center console 2′ arranged next to the first center console 2 is coupled to the passenger seat 1′ via a connecting rod 6′. The center console system 100 corresponds to that of FIG. 1, wherein the center console system 100′ corresponds to that of FIG. 1, with the proviso that the center console 2′ is coupled to the passenger seat 1′.

In one embodiment, the first center console 2 and the second center console 2′ can have a common second hinge 42 or separate second hinges 42 and 42′ for coupling the center console to the support structure 3 (not visible in FIG. 3).

What is claimed is:

1. A center console system for use in a vehicle interior, comprising:
a support structure,
a center console, and
a vehicle seat movable relative to the support structure along a first direction and along a second direction, wherein the center console is arranged next to the vehicle seat and is connected thereto via a first hinge such that a movement of the vehicle seat is transmitted to the center console, and wherein the center console is connected to the support structure via a second hinge in a rotating manner.

2. The center console system according to claim 1, wherein the first direction runs orthogonally to the second direction, wherein at least one of the first hinge or the second hinge is designed such that the center console is rotatable about an axis running along a third direction, and wherein the third direction is orthogonal to the first direction and the second direction.

3. The center console system according to claim 1, wherein at least a part of the center console is mounted on the support structure in a translationally displaceable manner.

4. The center console system according to claim 1, wherein a distance between the first hinge and the second hinge is adjustable.

5. The center console system according to claim 1, wherein the center console includes a telescopic mechanism or a folding mechanism for length adjustment.

6. The center console system according to claim 1, wherein the first hinge connects the center console to the vehicle seat in a rotatable manner, and wherein the first hinge connects the center console to the vehicle seat via a connecting rod.

7. The center console system according to claim 1, wherein the support structure is part of a cockpit of a vehicle, and wherein the support structure includes an instrument panel.

8. The center console system according to claim 1, comprising:
a drive member, wherein the drive member is an electric motor, and wherein the drive member is arranged and designed to move the vehicle seat together with the center console relative to the support structure along at least one of the first direction or the second direction.

9. The center console system according to claim 1, wherein the center console includes at least one of: at least one storage compartment, a cup holder, or one or more electrical connections.

10. A vehicle comprising:
at least one center console system, the at least one center console system comprising:
a support structure;
a center console; and
a vehicle seat movable relative to the support structure along a first direction and along a second direction, wherein the center console is arranged next to the vehicle seat and is connected thereto via a first hinge such that a movement of the vehicle seat is transmitted to the center console, and wherein the center console is connected to the support structure via a second hinge in a rotating manner.

11. The vehicle according to claim 10, wherein the first direction runs orthogonally to the second direction, wherein at least one of the first hinge or the second hinge is designed such that the center console is rotatable about an axis running along a third direction, and wherein the third direction is orthogonal to the first direction and the second direction.

12. The vehicle according to claim 10, wherein at least a part of the center console is mounted on the support structure in a translationally displaceable manner.

13. The vehicle according to claim 10, wherein a distance between the first hinge and the second hinge is adjustable.

14. The vehicle according to claim 10, wherein the center console includes a telescopic mechanism or a folding mechanism for length adjustment.

15. The vehicle according to claim 10, wherein the first hinge connects the center console to the vehicle seat in a rotatable manner, and wherein the first hinge connects the center console to the vehicle seat via a connecting rod.

16. The vehicle according to claim 10, wherein the support structure is part of a cockpit of a vehicle, and wherein the support structure includes an instrument panel.

17. The vehicle according to claim 10, wherein the at least one center console system further includes:
a drive member, wherein the drive member is an electric motor, and wherein the drive member is arranged and designed to move the vehicle seat together with the center console relative to the support structure along at least one of the first direction or the second direction.

18. The vehicle according to claim 10, wherein the center console includes at least one of: at least one storage compartment, a cup holder, or one or more electrical connections.
